(19) United States
(12) Patent Application Publication
(10) Pub. No.: US 2021/0156426 A1
(43) Pub. Date: May 27, 2021

(54) METHOD OF ASSEMBLING MULTI-CAGE THRUST BEARING

(71) Applicant: Schaeffler Technologies AG & Co. KG, Herzogenaurach (DE)

(72) Inventors: James Brown, ROCK HILL, SC (US); Benjamin Kanda, Hamtramck, MI (US); Neil Hoan, CHARLOTTE, NC (US)

(73) Assignee: Schaeffler Technologies AG & Co. KG, Herzogenaurach (DE)

(21) Appl. No.: 16/692,059

(22) Filed: Nov. 22, 2019

(51) Int. Cl. F16C 33/54; F16C 19/30

(52) U.S. Cl. CPC F16C 33/543; B21D 53/12; F16C 33/541; F16C 19/30

(57) ABSTRACT

A method of assembling a multi-row thrust bearing cage is disclosed. The method includes providing an inner cage and an outer cage, the inner cage including a first retainer and a first alignment guide, and the outer cage including a second retainer and a second alignment guide. The method includes positioning the inner cage and the outer cage relative to each other such that the first alignment guide is circumferentially aligned with the second alignment guide. The method also includes inserting the inner cage relative to the outer cage such that the first retainer of the inner cage engages with the second retainer of the outer cage and the inner cage is retained with the outer cage.

### FIELD OF INVENTION

The present disclosure relates to a thrust bearing assembly, and more specifically relates to a method of assembling a multi-cage thrust bearing assembly.

### BACKGROUND

Bearing arrangements are well known. One type of bearing is a thrust bearing, which includes at least one cage for supporting rolling elements in the cage. Some types of bearings include multiple rows of rolling elements, and multiple thrust cages for supporting the rolling elements.

Assembling these types of bearings can be difficult due to any number of issues. One type of bearing, as shown in FIGS. 1A and 1B, requires a flanged washer to encapsulate the bearing assembly. This assembly can be complicated and the specially formed washers are more expensive than standard, flat plate washers.

Another type of bearing is shown in FIGS. 1C and 1D. This arrangement requires adjacent rolling elements to be secured in a common rolling element pocket, and therefore limits the number of rolling elements for the outer race. It is not possible to increase a number of rolling elements in the second row of the bearing to increase load carrying capacity.

Finally, FIG. 1E illustrates a double row thrust bearing that requires two, completely separate and discrete cage units. The cage units lack any type of alignment indicia or mating features between one another, and the end user or consumer is responsible for assembling the separate cages which often results in misalignment or errors.

Accordingly, there is generally a need for an improved method of assembling a multi-row thrust bearing assembly that fully meets the performance load demands of consumers.

### SUMMARY

A method of assembling a multi-row thrust bearing cage is disclosed. The method includes providing an inner cage and an outer cage, the inner cage including a first retainer and a first alignment guide, and the outer cage including a second retainer and a second alignment guide. The method includes positioning the inner cage and the outer cage relative to each other such that the first alignment guide is circumferentially aligned with the second alignment guide. The method also includes inserting the inner cage relative to the outer cage such that the first retainer of the inner cage engages with the second retainer of the outer cage and the inner cage is retained with the outer cage. In one embodiment, the cage is a sigma cage. The inner cage and the outer cage are formed from sheet metal.

The method also includes arranging a first washer and a second washer on either axial side of the inner cage and the outer cage. The first washer and the second washer each have a flat profile. The inner cage and the outer cage each include: an inner rim, an outer rim, and a plurality of crossbars extending between the inner rim and the outer rim to define a plurality of rolling element pockets. The plurality of crossbars of the inner cage and the outer cage are aligned with each other in a radially extending plane. The outer rim of the outer cage is radially aligned with radially outer edges of the first washer and the second washer.

In one embodiment, the inner rim and the outer rim of the inner cage and the outer cage extend in a single axial direction. The first retainer on the inner cage includes a circular opening and the second retainer on the outer cage includes a radially inwardly extending protrusion. The first retainer and the first alignment guide are positioned circumferentially from each other by a first angle, and the second retainer and the second alignment guide are positioned circumferentially from each other by a second angle that is identical to the first angle. In one embodiment, the first alignment guide includes a radially outwardly extending tab, and the second alignment guide includes a slot.

The method further includes inserting rolling elements into rolling element pockets defined by the inner cage and the outer cage prior to inserting the inner cage relative to the outer cage. In one embodiment, the outer cage includes more rolling elements than the inner cage.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIGS. 1A-1E illustrate various embodiments of thrust bearing cages according to the prior art.

FIG. 2A is a perspective view of a thrust bearing assembly with washers.

FIG. 2B is a perspective of the thrust bearing assembly of FIG. 2A without the washers.

FIG. 2C is a front view of the thrust bearing assembly of FIGS. 2A and 2B.

FIG. 2D is a cross-sectional view of the thrust bearing assembly of FIG. 2C through line 2D-2D.

FIG. 2E is a cross-sectional view of the thrust bearing assembly of FIG. 2C through line 2E-2E.

FIG. 2F is a cross-sectional view of the thrust bearing assembly of FIG. 2C through line 2F-2F.

FIG. 2G is a perspective cross-sectional view through a first region of the thrust bearing assembly of FIGS. 2A-2F.

FIG. 2H is a perspective cross-sectional view through a second region of the thrust bearing assembly of FIGS. 2A-2G.

FIG. 2I is a magnified perspective view of a first region of an outer rim of an inner cage of the thrust bearing assembly.

FIG. 2J is a magnified perspective view of a second region of the outer rim of the inner cage of the thrust bearing assembly.

FIG. 2K is a magnified perspective view of a first region of an inner rim of an outer cage of the thrust bearing assembly.

FIG. 2L is a magnified perspective view of a second region of the inner rim of the outer cage of the thrust bearing assembly.

FIG. 3A is a perspective view of an alternative embodiment of a thrust bearing assembly.

FIG. 3B is a magnified perspective view of the thrust bearing assembly of FIG. 3A.

FIG. 4A is a perspective view illustrating a method step of assembling the thrust bearing assembly of FIGS. 2A-2L prior to insertion of rolling elements.

FIG. 4B is a perspective view illustrating a method step of assembling the thrust bearing assembly of FIGS. 2A-2L after insertion of the rolling elements.

FIG. 4C is a perspective view illustrating a method step of assembling the thrust bearing assembly of FIGS. 2A-2L prior to inserting an inner cage relative to an outer cage.

FIG. 4D is a perspective view illustrating a method step of assembling the thrust bearing assembly of FIGS. 2A-2L during insertion of the inner cage relative to the outer cage.

FIG. 4E is a perspective view illustrating a method step of assembling the thrust bearing assembly of FIGS. 2A-2L after insertion of the inner cage relative to the outer cage.

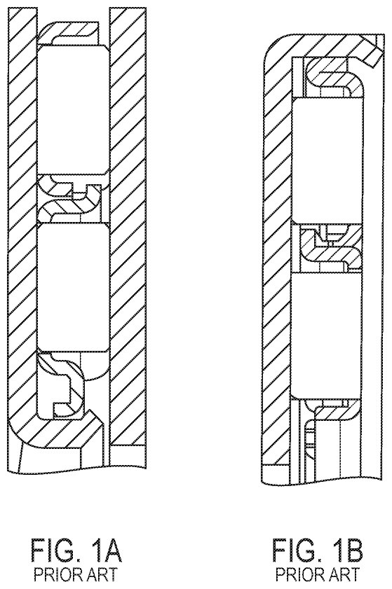

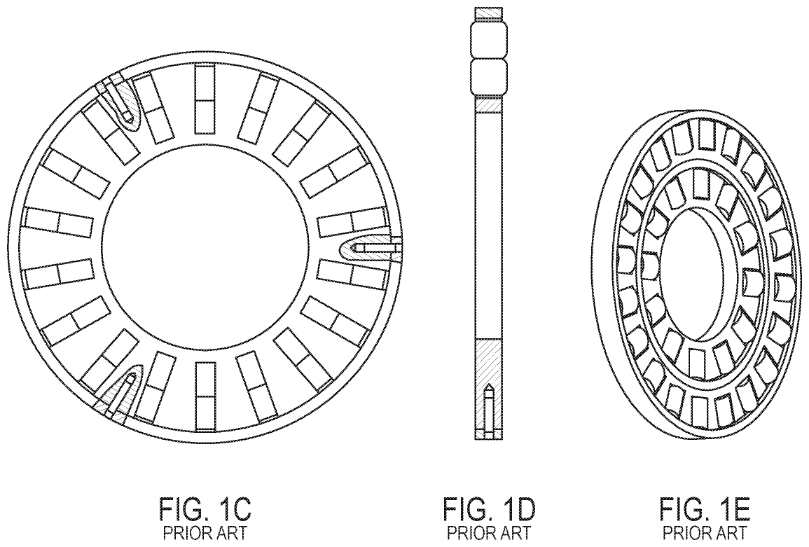

### DETAILED DESCRIPTION OF THE PREFERRED EMBODIMENTS

Certain terminology is used in the following description for convenience only and is not limiting. The words “inwardly” and “outwardly” refer to directions toward and away from the parts referenced in the drawings. “Axially” refers to a direction along the axis of a bearing. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

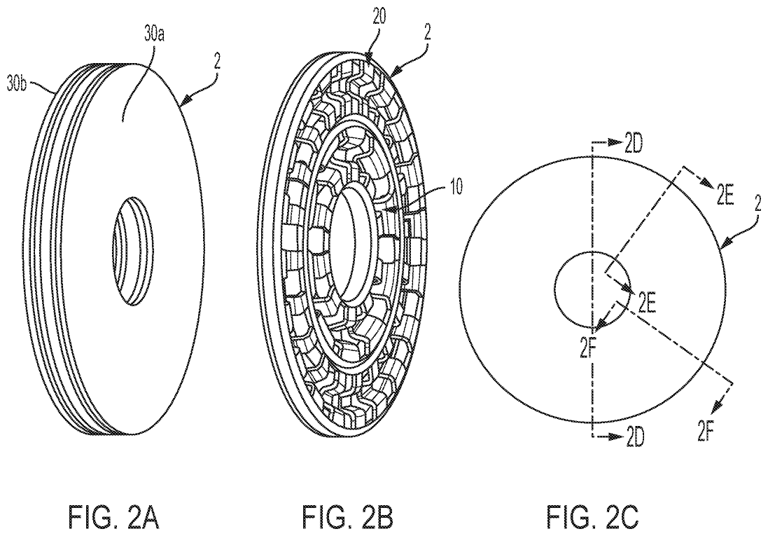

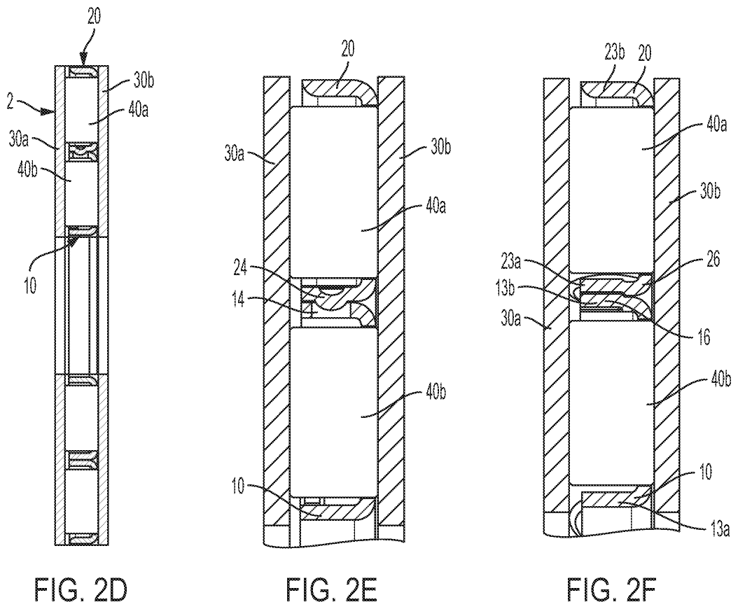

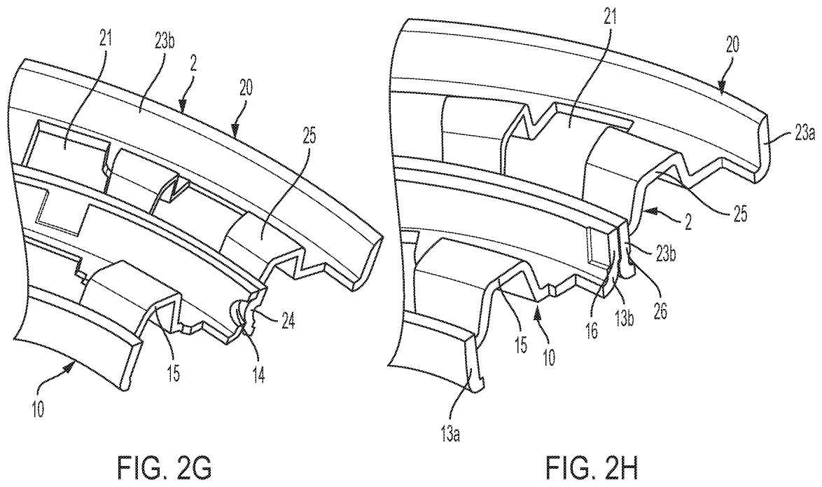

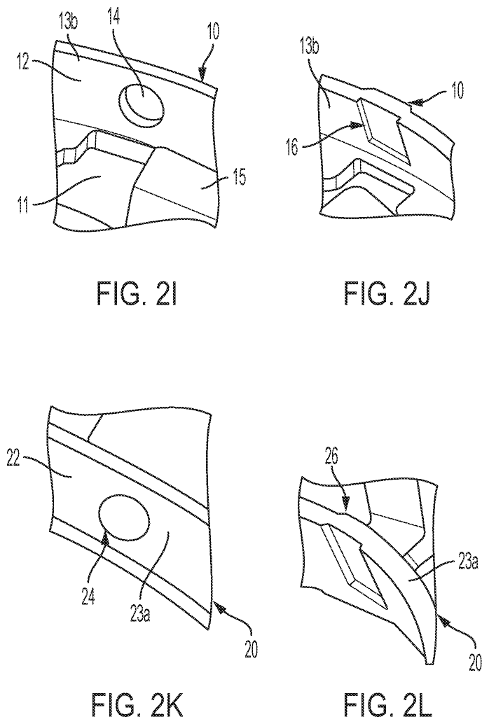

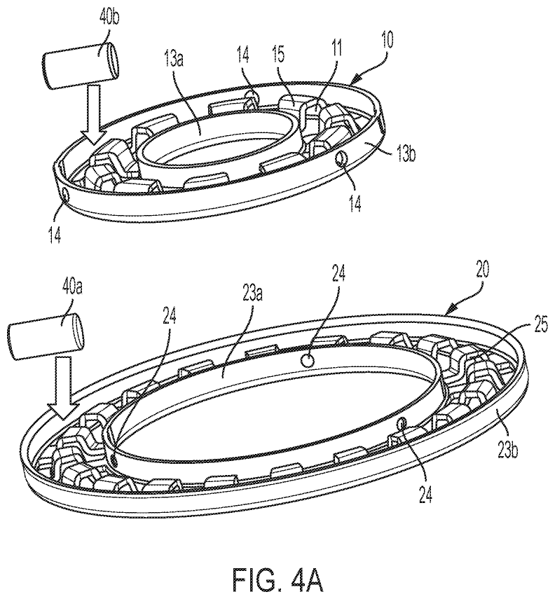

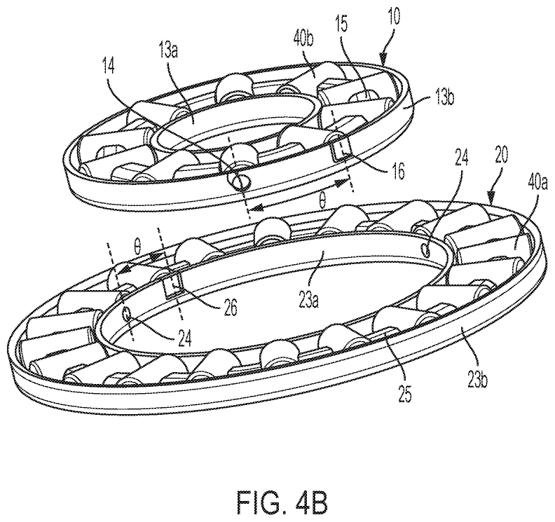

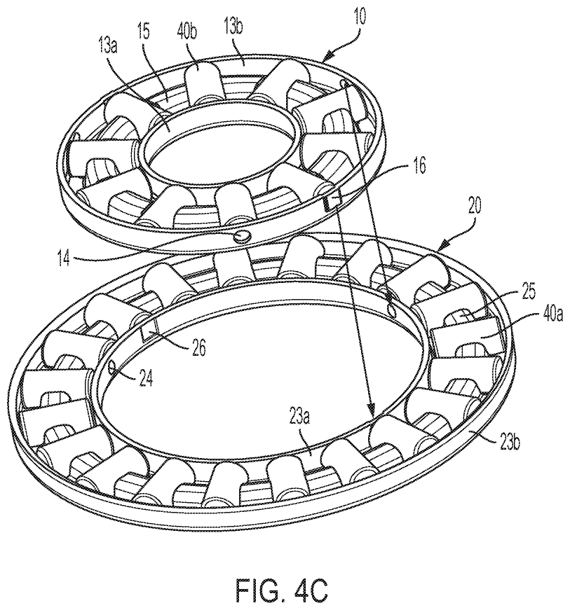

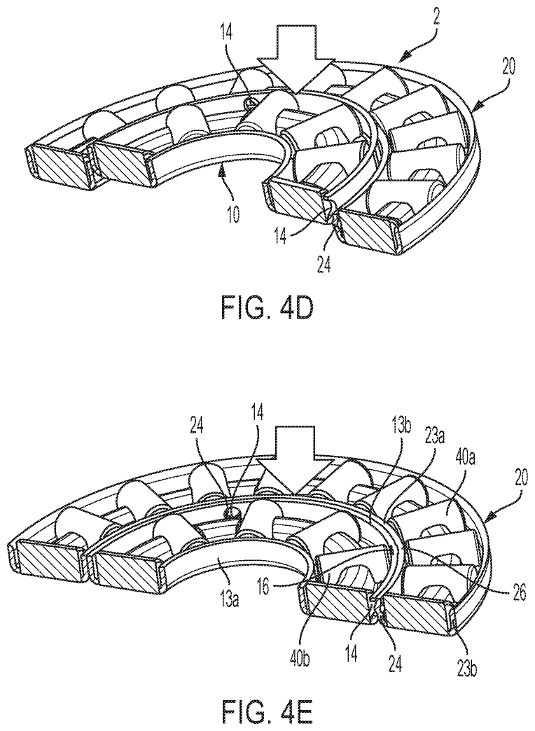

FIGS. 2A-2L illustrate a thrust bearing assembly 2 and FIGS. 4A-4E illustrate steps for assembling the thrust bearing assembly 2. The thrust bearing assembly 2 includes an inner cage 10 and an outer cage 20. This disclosure generally provides two features on at least one of the rims of the cages. At least one of the rims on each of the cages includes (i) an orientation or alignment feature, and (ii) a retaining, mating, snapping, or connecting feature. These features are described in more detail herein.

In one embodiment, the inner cage 10 includes an inner rim 13a and an outer rim 13b, with a plurality of crossbars 15 extending therebetween to define rolling element pockets 11. The outer cage 20 also includes an inner rim 23a, and an outer rim 23b, with a plurality of crossbars 25 extending therebetween to define rolling element pockets 21.

As shown in FIGS. 2D-2H, the crossbars 15, 25 of the inner and outer cages 10, 20 are identical and are aligned in a radially extending plane. As shown in the drawings, the cages 10, 20 are illustrated as sigma cages. One of ordinary skill in the art would understand that other types of cages could be used, such as any type of formed box cage. The inner cage 10 and the outer cage 20 are preferably formed from sheet metal. The cages 10, 20 are preferably formed by stamping.

The inner cage 10 includes a first retainer 14 and a first alignment guide 16, and the outer cage 20 includes a second retainer 24 and a second alignment guide 26. As illustrated in the drawings, the first retainer 14 is shown as a circular opening and the second retainer 24 is illustrated as a radially inwardly extending round protrusion. The first alignment guide 16 is illustrated a radially outwardly extending tab and the second alignment guide 26 is illustrated as a slot.

The term opening is used herein to refer to any void or recess, and the opening can be formed by punching. The term protrusion is used herein to refer to any bump, raised portion, protuberance or other non-flat structure, and can also be formed by punching. The term tab is also used herein to refer to a raised portion, and in one embodiment the tab has a rectangular profile. The term slot is used herein to refer to a recessed or indented portion. The tabs and slots can be formed by punching. Instead of the inner cage 10 including the circular opening 14, one of ordinary skill in the art would understand that the outer cage 20 could include the circular opening (instead of the protrusion 24). Similarly, the inner cage 10 can include the slot and the outer cage 20 can include the tab.

One of ordinary skill in the art would understand that the quantity and location of the tabs, slots, protrusions and openings can vary depending on the specific performance requirements of a bearing.

The method includes positioning the inner cage 10 and the outer cage 20 relative to each other such that the first alignment guide 16 is circumferentially aligned with the second alignment guide 26. The method includes inserting the inner cage 10 inside of the outer cage 20 such that the first retainer 14 of the inner cage 10 engages with the second retainer 24 of the outer cage 20. The engagement between these components provides a snapped connection such that the inner cage 10 and the outer cage 20 are captively secured to each other and suitable for use without disconnecting from each other.

The method further includes arranging a first washer 30a and a second washer 30b on either axial side of the inner cage 10 and the outer cage 20. As shown in FIGS. 2D-2F, the first washer 30a and the second washer 30b each have a flat, disk-like profile. The outer rim 23b of the outer cage 20 is radially aligned with radially outer edges of the first washer 30a and the second washer 30b. In other words, the radially outer edge of the thrust bearing assembly 2 consists of the radially outer edges of the washers 30a, 30b and the radially outer edge of the outer rim 23b of the outer cage 20. The crossbars 15, 25 extend in an axial direction and are unsupported or free standing from the washers 30a, 30b.

As shown most clearly in FIGS. 2D-2F, the inner rim 13a, 23a and the outer rim 13b, 23b of the inner cage 10 and the outer cage 20 extend in a single axial direction. In other words, the free ends of the rims 13a, 23a, 13b, 23b all extend in a single axial direction.

As shown in FIG. 4B, the first retainer 14 and the first alignment guide 16 are positioned circumferentially from each other by a first angle θ, and the second retainer 24 and the second alignment guide 26 are positioned circumferentially from each other by a second angle θ that is identical to the first angle θ. This configuration ensures that the retainers and alignment guides are properly oriented.

In one embodiment, as shown in FIG. 4A, the method includes inserting rolling elements 40a, 40b into rolling element pockets 11, 21 defined by the inner cage 10 and the outer cage 20 prior to inserting the inner cage 10 relative to the outer cage 20. As shown most clearly in FIG. 4B, the outer cage 20 includes more rolling elements 40a, 40b than the inner cage 10. In one embodiment, the outer cage 20 includes twice as many rolling elements as the inner cage 10. This configuration provides improved load capacity for the thrust bearing assembly.

FIG. 4C illustrates aligning the retainers 14, 24 and alignment guides 16, 26 prior to insertion of the inner cage 10 within the outer cage 20. FIGS. 4D and 4E show the final steps of the assembly of the inner cage 10 within the outer cage 20. FIG. 4E illustrates the fully assembled thrust bearing assembly 2, with the retainers 14 24 fully engaged such that the inner cage 10 is secured to the outer cage 20.

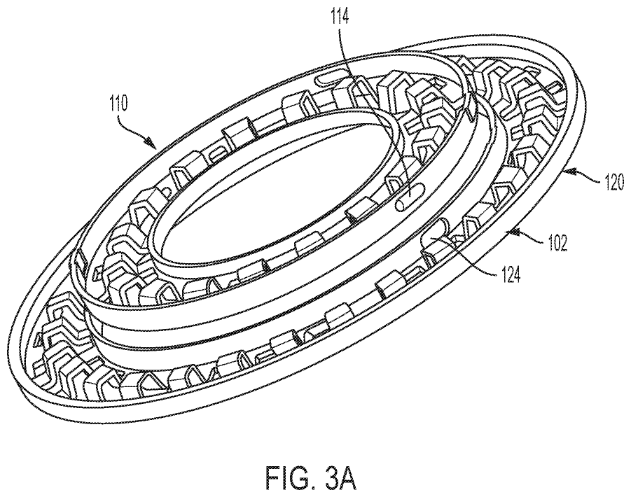

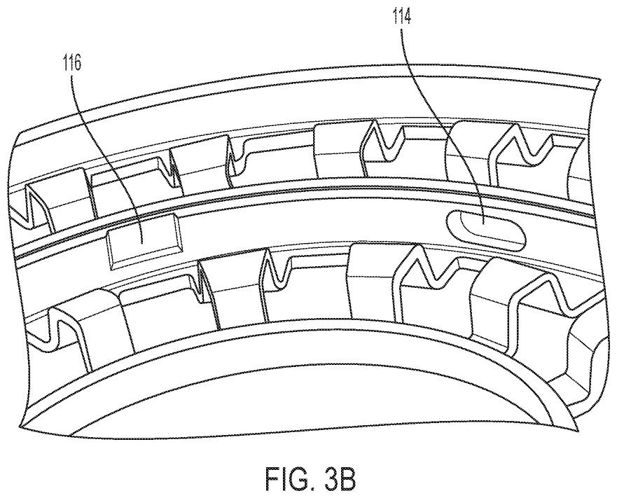

FIGS. 3A and 3B illustrate a variation of the retainers described herein. In this embodiment, the assembly 102 similarly includes an inner cage 110 and outer cage 120, but the retainers 114, 124 have an oval shaped profile. The other features not described in more detail herein are otherwise identical to the features of the embodiment of FIGS. 2A-2L and FIGS. 4A-4E. One of ordinary skill in the art would understand that the shape of the retainers can be varied.

The shape of the retainers 14, 24 and the alignment guides 16, 26 ensure that a user or assembly personnel cannot push the inner cage 10 beyond the desired position relative to the outer cage 20. For example, the retainer 14 (i.e. opening) on the inner cage 10 is captively secured within the retainer 24 (i.e. protrusion), and the first alignment guide 16 is angled (shown most clearly in FIG. 2F) such that the first alignment guide 16 abuts an end stop defined by the second alignment guide 26.

Retention between the cages 10, 20 is accomplished exclusively via the cages 10, 20. In other words, securing the cages 10, 20 to each other does not require any additional retention features on the washers or separate fixing elements.

Although two cages are shown in the drawings, one of ordinary skill in the art would understand that this arrangement can be easily adapted for more than two cages, such that each additional larger cage includes more rolling elements than the inner cages.

Having described the present disclosure in detail, it is to be appreciated and will be apparent to those skilled in the art that many physical changes, only a few of which are exemplified in the detailed description of the embodiments, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

Thrust bearing assembly 2, 102

Inner cage 10, 110

Rolling element pocket 11, 21

Inner rim 13a, 23a

Outer rim 13b, 23b

First retainer 14, 114

Crossbar 15, 25

First alignment guide 16, 116

Outer cage 20, 120

Second retainer 24, 124

Second alignment guide 26

Washer 30a, 30b

Rolling element 40a, 40b

What is claimed is:

1. A method of assembling a multi-row thrust bearing cage, the method comprising:
providing an inner cage and an outer cage, the inner cage including a first retainer and a first alignment guide, the outer cage including a second retainer and a second alignment guide;
positioning the inner cage and the outer cage relative to each other such that the first alignment guide is circumferentially aligned with the second alignment guide; and
inserting the inner cage relative to the outer cage such that the first retainer of the inner cage engages with the second retainer of the outer cage and the inner cage is retained with the outer cage.

2. The method of claim 1, wherein the inner cage and the outer cage are each a sigma cage.

3. The method of claim 1, further comprising:
arranging a first washer and a second washer on either axial side of the inner cage and the outer cage, wherein the first washer and the second washer each have a flat profile.

4. The method of claim 3, wherein the inner cage and the outer cage each include:
an inner rim, an outer rim, and a plurality of crossbars extending between the inner rim and the outer rim to define a plurality of rolling element pockets.

5. The method of claim 4, wherein the plurality of crossbars of the inner cage and the outer cage are aligned in a radially extending plane.

6. The method of claim 4, wherein the outer rim of the outer cage is radially aligned with radially outer edges of the first washer and the second washer.

7. The method of claim 4, wherein the inner rim and the outer rim of the inner cage and the outer cage extend in a single axial direction.

8. The method of claim 1, wherein the first retainer on the inner cage includes a circular opening and the second retainer on the outer cage includes a radially inwardly extending protrusion.

9. The method of claim 1, wherein the first retainer and the first alignment guide are positioned circumferentially from each other by a first angle, and the second retainer and the second alignment guide are positioned circumferentially from each other by the first angle.

10. The method of claim 1, wherein the first alignment guide includes a radially outwardly extending tab, and the second alignment guide includes a slot.

11. The method of claim 1, wherein the inner cage and the outer cage are formed from sheet metal.

12. The method of claim 1, further comprising inserting rolling elements into rolling element pockets defined by the inner cage and the outer cage.

13. The method of claim 1, wherein the outer cage includes more rolling element pockets than the inner cage.

14. A method of assembling a multi-row thrust bearing cage, the method comprising:
(i) providing an inner cage and an outer cage, the inner cage including a first retainer and a first alignment guide, the outer cage including a second retainer and a second alignment guide;
(ii) positioning the inner cage and the outer cage relative to each other such that the first alignment guide is circumferentially aligned with the second alignment guide;
(iii) inserting the inner cage relative to the outer cage such that the first retainer of the inner cage engages with the second retainer of the outer cage; and
(iv) arranging a first washer and a second washer on either axial side of the inner cage and the outer cage, wherein the first washer and the second washer each have a flat profile,
wherein the first retainer on the inner cage includes an opening and the second retainer on the outer cage includes a radially inwardly extending protrusion, and
the first alignment guide includes a radially outwardly extending tab, and the second alignment guide includes a slot.

15. The method of claim 14, wherein the inner cage and the outer cage are each a sigma cage.

16. The method of claim 14, wherein the first retainer and the first alignment guide are spaced circumferentially from each other by a first angle, and the second retainer and the second alignment guide are spaced circumferentially from each other by a second angle that is identical to the first angle.

17. A multi-row thrust bearing cage comprising:
an inner cage including a first inner rim, a first outer rim, a first plurality of crossbars extending between the first inner rim and the first outer rim to define a first plurality of rolling element pockets, and a first retainer and a first alignment guide defined on the first outer rim; and
an outer cage including a second inner rim, a second outer rim, a second plurality of crossbars extending between the second inner rim and the second outer rim to define a second plurality of rolling element pockets, and a second retainer and a second alignment guide defined on the second inner rim,
wherein the inner cage and the outer cage are captively secured to each other via alignment of the first alignment guide and the second alignment guide and direct engagement between the first retainer and the second retainer.

18. The cage of claim 17, wherein the outer cage includes more rolling element pockets than the inner cage.

19. The cage of claim 17, wherein the first inner rim and the first outer rim of the inner cage, and the second inner rim and the second outer rim of the outer cage each extend in a single axial direction.

20. The cage of claim 17, further comprising a first washer and a second washer on either axial side of the inner cage and the outer cage, wherein the first washer and the second washer each have a flat profile.
